(19) United States
(12) Patent Application Publication
(10) Pub. No.: US 2008/0014117 A1
(43) Pub. Date: Jan. 17, 2008

(54) Food sterilization dosage indicator

(75) Inventors: John M. Questel, Stow, OH (US); Christian D. Sokolowski, Akron, OH (US)

Correspondence Address: Edward G. Greive;Renner, Kenner, Greive, Bobak, Taylor & Weber, Fourth Floor, First National Tower, Akron, OH, 44308-1456, US

(73) Assignee: Questel Adhesives

(21) Appl. No.: 11/486,811

(22) Filed: Jul. 14, 2006

(51) Int. Cl. G01N 31/22

(52) U.S. Cl. 422/56; 436/170

(57) ABSTRACT

A multilayer food sterilization dosage indicator having (a) an indicator layer including an ion-sensitive ink, an ionic photoinitiator, a proton source; (b) a substrate, and an overlayer including a UV-absorber. The ink undergoes a color change upon exposure to a known amount of sterilizing radiation. A method for indicating the amount of exposure to sterilizing radiation using the dosage indicator.

### FIELD OF THE INVENTION

The present invention relates to a multilayer device that can be used to label foods. The label can indicate whether the food has been exposed to sterilizing radiation. More specifically, the present invention relates to a multilayer food sterilization dosage indicator and a method for indicating the amount of exposure to sterilizing radiation.

### BACKGROUND OF THE INVENTION

Food irradiation has been approved for use in many countries. In the United States, the Food and Drug Administration (FDA) has approved irradiation for eliminating insects from wheat, potatoes, flour, spices, tea, fruits, and vegetables. Irradiation can also be used to control sprouting and ripening. In addition, irradiation can be used to control harmful bacteria and organisms in meat, for example trichinosis in pork, and salmonella in chicken, turkey, and other fresh and frozen uncooked poultry.

In approving a use of radiation, the FDA sets the maximum radiation dose the product can be exposed to, measured in units called kiloGray (kGy). The dose, i.e. the amount of radiation that a substance is exposed to, must be carefully measured and monitored. Over exposure to gamma radiation will cause cooking of the food, and undesirable taste, color, or mouth feel variations. A dosage of 4.5 kGy is equivalent to the irradiation dosage of 7 million chest X-rays.

The following is a list of approved uses of radiation on foods, the purpose for irradiating them, and the maximum radiation dose allowed, from FDA Publication No. 98-2320.

| FOOD | APPROVED USE | DOSE | |
|---|---|---|---|
| Spices and dry | Decontaminates and controls | 30 | kGy |
| vegetable seasoning | insects and microorganisms | | |
| Dry or dehydrated | Controls insects and | 10 | kGy |
| enzyme preparations | microorganisms | | |
| All foods | Controls insects | 1 | kGy |
| Fresh foods | Delays maturation | 1 | kGy |
| Poultry | Controls disease-causing | 3 | kGy |
| | microorganisms | | |
| Red meat | Controls spoilage and disease- | 4.5 | kGy (fresh) |
| | causing microorganisms | 7 | kGy (frozen) |

Known methods of monitoring exposure to gamma radiation include using a photographic film that is exposed to the irradiation at the same time as the product, and that fogs at a rate proportional to the irradiation dosage. However, photographic films are not able to measure the low dosages of gamma radiation typically used for food sterilization.

U.S. Pat. No. 5,206,118 teaches a color-change dosimeter film including an acid-sensitive leuco dye dispersed in an organosol of a halogen-containing polymer. The dosimeter can detect a broad range of kilograys, from 0.1 to 1000.

Indicator-type devices have been developed for detecting exposure to ultraviolet radiation. U.S. Pat. No. 5,436,115 teaches a photochemical system wherein a photoacid is formed upon irradiation of a nitro-substituted aromatic aldehyde with ultraviolet light and wherein proton transfer to a dye causes the dye to undergo a visible color change to an extent directly proportional to the cumulative amount of radiation. The '115 indicator is designed to change color in response to the ultraviolet radiation found in sunlight, and is thus a sunlight dosage indicator.

U.S. Pat. No. 6,475,433 describes a photochromic material that undergoes a change in appearance when exposed to UVC radiation. The photochromic material is suggested for use on an indicator strip for monitoring the sterilization of an aqueous solution, or can be placed on a surface such as a medical instrument.

An indicating label that can indicate the exposure of food to sterilizing radiation dosages in the 1.5-9.0 kGy range is needed. A device that provides a stable indication of exposure to sterilizing radiation accurately and over an extended period of time is desirable.

### SUMMARY OF THE INVENTION

In light of the foregoing, it is a first aspect of the present invention to provide a multilayer device sterilization dosage indicator comprising an indicator layer comprising an ion-sensitive ink and an ionic photoinitiator, wherein the ink undergoes a color change upon exposure of the indicator to a known amount of sterilizing radiation.

Another aspect of the present invention is to provide a method for indicating the amount of exposure to sterilizing radiation. This aspect of the present invention is achieved by providing a multilayer dosage indicator comprising (a) an indicator layer comprising an ion-sensitive ink and an ionic photoinitiator; and (b) a label substrate, wherein the ink undergoes a color change upon exposure of the indicator to a known amount of sterilizing radiation, and wherein the color change indicates exposure to an amount of radiation in the range of from about 1.5 to about 9 kGy.

A further aspect of the present invention is to provide a method for improving the selectivity of the food sterilization dosage indicator. This aspect of the present invention is achieved by (1) providing a multilayer sterilization dosage indicator comprising: (a) an indicator layer comprising an ion-sensitive ink and an ionic photoinitiator, wherein the ink undergoes a color change upon exposure of the indicator to a known amount of sterilizing radiation; (b) a label substrate, and (c) an overlayer comprising at least one ultraviolet radiation absorber.

Yet another aspect of the present invention is to provide a method for improving the stability of the food sterilization dosage indicator. This aspect of the present invention is achieved by (1) providing a multilayer sterilization dosage indicator comprising: (a) an indicator layer comprising an ion-sensitive ink and an ionic photoinitiator, wherein the ink undergoes a color change upon exposure of the indicator to a known amount of sterilizing radiation; (b) a label substrate, (c) an overlayer comprising at least one ultraviolet radiation absorber; and (d) an intermediate layer between the indicator layer and the substrate layer, wherein the intermediate layer prevents any chemical interaction between the indicator layer and the substrate layer.

Other aspects of the present invention, as well as the advantages thereof over existing prior art forms, will become apparent from the following brief description considered and interpreted in view of the accompanying drawing, and are accomplished by the improvements hereinafter described and claimed.

### BRIEF DESCRIPTION OF THE DRAWING

For a complete understanding of the objects, techniques and structure of the invention, reference should be made to the following detailed description and accompanying drawing wherein:

FIG. 1 is a sectional view of the food sterilization dosage indicator according to a preferred embodiment of the present invention.

### BRIEF DESCRIPTION OF THE PREFERRED EMBODIMENTS

The present invention relates to a multilayer device that can be used to indicate exposure to sterilizing radiation in a dosage range of from about 1.5 to about 9 kGy. By sterilizing radiation is meant radiation that is typically used to sterilize food. In one embodiment, sterilizing radiation includes gamma radiation emitted from radioactive cobalt, such as cobalt 60, or cesium, such as cesium 137, or accelerators that can produce electrons, x-rays or both.

In one embodiment, the multilayer device of the present invention includes an indicator layer comprising an ion-sensitive ink, an ionic photoinitiator, and a proton source. The indicator layer may further include other optional materials.

For purposes of this specification, an ion-sensitive ink is a material that reliably changes color upon exposure to sterilizing radiation when within the indicator layer formulation of the present invention. Ion-sensitive inks include, but are not limited to, bromochlorophenol blue sodium salt, bromocresol green ACS, bromocresol green sodium salts ACS, bromocresol purple, bromocresol purple sodium salt, bromopyrogallol red, bromothymol blue ACS, bromothymol blue sodium salt ACS, bromoxylenol blue, chlorophenol red, o-cresolphthalein complexone, o-cresolphthalein complexone disodium salt, m-cresol purple, m-cresol purple sodium salt, cresol red, cresol red sodium salt, erichrome blue black R, ethyl orange sodium salt, fast sulphon black F, litmus powder, methyl orange ACS, methyl red free acid ACS, methyl red HCl ACS, methyl red sodium salt ACS, methylthymol blue, murexide powder, nitrazine yellow, and P.A.N. In one or more embodiments, the ion-sensitive ink comprises ethyl orange. Ethyl orange, also known as 4′-diethylaminoazobenzene-4-sodium sulfonate, is available from Dudley Chemical Corporation.

The amount of ion-sensitive ink is not particulary limited, but should be an effective amount to produce a color or a color transition that is discernable to the human eye. In one embodiment, the indicator layer includes ion-sensitive ink in an amount of from about 3 to about 20 parts by weight (pbw) per 100 pbw binder, and in another embodiment, from about 5 to about 15 pbw per 100 pbw binder.

In one embodiment, the ionic photoinitiator includes a cationic photoinitiator such as those known in the art of polymerization or curing, although it will be understood that polymerization is not involved in the food sterilization indicator of the present invention. Cationic photoinitiators include iodine-containing nucleophiles such as iodonium salts, sulphonium-containing nucleophiles such as sulphonium salts, iron arene complexes, and diazonium salts such as tetrafluoroborate, hexafluorophosphate, hexafluoroarsenate, and hexafluoroantimonate diazonium salts.

Examples of cationic photoinitiators include bis(p-tolyl)iodonium hexafluorophosphate, and substituted aryl sulfonium hexafluorophosphate salts. Iodine-containing photoinitiators are available commercially, for example under the trade name R-GEN 1130 from Chitec Technology Co. Ltd. Sulfonium-containing photoinitiators are available commercially, for example as a substituted aryl sulfonium hexafluorophosphate salt under the trade name R-GEN BF-1172 from Chitec Technology Co. Ltd.

In certain embodiments, the indicator layer includes cationic photoinitiator in an amount of from about 4 to about 20 pbw per 100 pbw binder, and in another embodiment, from about 5 to about 15 pbw per 100 pbw binder.

In one embodiment, the indicator layer further includes a free-radical photoinitiator. In certain embodiments, the free-radical photoinitiator enhances the color transition of the ion-sensitive ink. Examples of free-radical photoinitiators include 2-hydroxy-2-methyl-1-phenyl-propane-1-one, available under the trade name Chivacure 173 from Chitec Technology Co. Ltd.

In certain embodiments, the indicator layer includes free-radical photoinitiator in an amount of from about 1.5 to about 8 pbw per 100 pbw binder, and in another embodiment, from about 2 to about 4 pbw per 100 pbw binder.

The proton source is a material that provides protons upon exposure to sterilizing radiation. In one or more embodiments, the proton source includes a binder that provides also film strength. In one embodiment, the binder degrades upon exposure to sterilizing radiation, and thus contributes to the color change. Examples of binders include PVDC. Specific examples of PVDC include an aqueous emulsion of a vinylidene chloride copolymer such as Polidene 33-004, available from Scott Bader Ltd. In one embodiment, the PVDC is selected by its ability to dehydrohalogenate upon exposure to sterilizing radiation. In one or more embodiments, the molecular weight of the PVDC is greater than about about 200,000.

In certain embodiments, the binder includes heat-treated PVDC. In one or more embodiments, the PVDC emulsion is heat-treated at a temperature of from about 32° C. to about 52° C. In one embodiment, the period of time of heat treatment may be at least about 6 hours, and in another embodiment, the period of time of heat treatment is at least about 8 hours. In yet another embodiment, the binder is heated for at least about 10 hours, and in still yet another embodiment, the binder is heated for at least about 12 hours. In one or more embodiments, the PVDC emulsion is heat-treated for a period of up to about 24 hours.

It is envisioned that, if a binder is employed that does not operate as a proton donor upon exposure to sterilizing radiation, then the indicator layer further comprises an additional component that is a proton source. In these or other embodiments, the proton donor maybe characterised as having a molecular weight of greater than about 1000, in another embodiment greater than about 5000, and in yet another embodiment, the proton donor is characterised by a molecular weight of greater than about 10,000.

In one or more embodiments, the indicator layer further includes one or more of fibers, surfactants, viscosity control agents, and color change enhancers. Examples of surfactants include Dowfax 2A1. In one embodiment, the indicator layer includes surfactant in an amount of from 0 to about 10 parts by weight (pbw) per 100 pbw binder, and in another embodiment, from about 0.1 to about 5 pbw per 100 pbw binder.

Examples of viscosity control agents include thickeners, such as polyether urea polyurethane, and specifically Rheolate® 288 from Elementis Specialties, Inc. In one embodiment, the indicator layer includes a viscosity control agent in an amount of from 0 to about 10 pbw per 100 pbw binder, and in another embodiment, from about 0.05 to about 5 pbw per 100 pbw binder.

Color change enhancers include components that affect the original color of the indicator layer, affect the resultant color of the indicator layer after irradiation with sterilizing radiation, or affect the degree of color. In one embodiment, the color change enhancer is a water soluble dye. Examples of color change enhancers include FD&C Blue. The amount of color change enhancer in the indicator layer is not particularly limited. In certain embodiments, the amount may be selected to provide a markedly different starting and end point colors for indicator labels.

In one or more embodiments, the ion-sensitive ink, cationic photoinitiator, and optionally other ingredients are mixed with a binder to form an indicator mixture. In one embodiment, the ingredients are mixed at a temperature of from about 22° C. to about 66° C.

If desired, one or more of the ingredients may be dissolved in a suitable solvent to form a masterbatch, and then added to the mixture. Suitable solvents include organic and inorganic solvents. Examples of solvents include water, methyl ethyl ketone, toluene, N-methylpyrolidone, and mixtures thereof. It will be understood that, when a component is premixed to form a solution or emulsion, the amount of solution or emulsion that is added to the indicator mixture may be selected so that the amount of the component in the mixture falls within the ranges set forth hereinabove.

In one embodiment of the present invention, the indicator layer mixture described above is applied to a substrate. Suitable substrates include any material to which the indicator layer will adhere. In certain embodiments, white or light-colored materials are selected because they do not mask the color change of the ion-sensitive ink. Examples of materials that may be used as a substrate include, but are not limited to, white lithographic paper, white polyvinyl chloride (PVC) film, or other paper, film, or foil having a white, opaque coating. Specific examples of substrate materials include 60 lb. Litho-paper, 0.00035 inch aluminum foil laminated to paper, and 0.002 inch aluminum foil laminated to paper.

In certain embodiments, the dosage indicator further comprises an intermediate layer between the substrate layer and the indicator layer. Suitable intermediate layers include, but are not limited to, any material that is substantially inert to the indicator layer. Examples of intermediate layers include aluminum foil, polyethylene terephthalate film (mylar), aluminum metallized mylar, and other impervious pastics. Coated paper may be used, with the proviso that the paper is coated with a barrier layer, i.e. a layer that is inert to the indicator layer. Without wishing to be bound by theory, it is believed that the intermediate layer may provide enhanced stability to the dosage indicator by preventing a reaction or interaction between the indicator layer and the substrate layer that may affect the color of the indicator layer.

In one embodiment, the intermediate layer includes a material that reflects sterilizing radiation. It is believed that, in this embodiment, radiation is reflected by the intermediate layer back through the indicator layer, and enhances the color change of the indicator layer. Thus, in one embodiment where the substrate layer is clay-coated litho-paper, the radiation indicator includes a layer of foil that is intermediate to the indicator layer and the substrate layer.

Certain of the ion-sensitive inks will change color upon exposure to ultraviolet (UV) radiation, as well as gamma radiation. Ultraviolet radiation is ubiquitous, inasmuch as it is present in sunlight. In order to prevent sunlight or other forms of UV radiation from causing premature color change in the food sterilization indicator, an overlayer may be employed to absorb UV radiation and prevent it from reaching the indicator layer. Thus, in one or more embodiments, the dosage indicator further comprises an overlayer that includes at least one UV-absorber. In certain embodiments, the overlayer improves the selectivity of the radiation dosage indicator to gamma radiation, and may provide improved abrasion resistance.

Ultraviolet radiation absorbers include substances that absorb UVA, UVB, and/or UVC radiation, i.e. radiation having a wavelength of from about 180 nanometers (nm) to about 380 nm. Examples of components that absorb ultraviolet radiation include cellulose such as ethyl cellulose, and light stabilizers such as benzophenones, benzotriazoles, triazines, substituted acrylonitriles, and phenol-nickel complexes. Benzophenones include 2,2′-dihydroxy-4-methoxybenzophenone, available as Cyasorb UV-24, from Cytec Industries.

Advantageously, adjustments in the amount of UV radiation absorbed may be made by adjusting the amount of UV-absorber in the overlayer. In general, the higher the concentration of UV-absorber in the overlayer, the more UV radiation will be absorbed. The amount of UV radiation absorbed by the overlayer may also be selected by adjusting the thickness of the overlayer. Typically, increasing the thickness of the overlayer increases the amount of UV radiation absorbed.

In one embodiment, the overlayer of the present invention comprises a colorless lacquer mixture formed from ingredients that include a UV-absorber, and may include one or more of a binder, a viscosity control agent, a polymer such as a polyester resin, and a solvent. The lacquer mixture may further include processing aids such as waxes, surfactants, and the like. Suitable binders include, but are not limited to, polyamide resins and acrylate resins. In one embodiment, the binder comprises maleic rosin resin, such as Unirez 8115, available from Union Camp Corp. In another embodiment, the binder comprises Elvacite 2028, available from Ineos Acrylics.

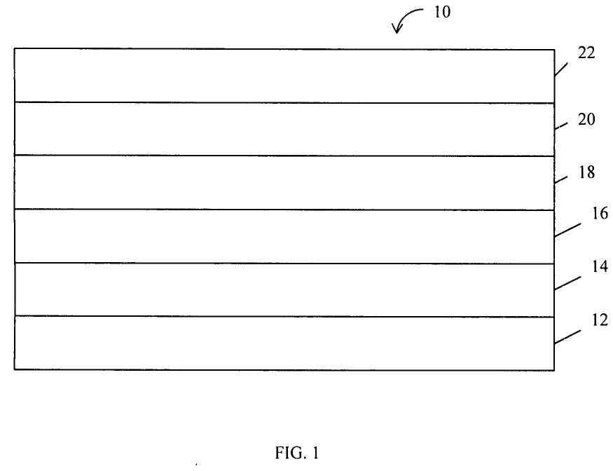

Referring now to FIG. 1, it can be seen that in one embodiment of the present invention, multilayer radiation dosage indicator 10 comprises a removable layer 12, an adhesive layer 14, a substrate 16, an intermediate layer 18, an indicator layer 20, and a clear overlayer 22.

Removable release layer 12 covers and protects adhesive layer 14 during storage and handling. Prior to use, removable release layer 12 is removed from indicator 10. This may be accomplished by, for example, peeling removable release layer 12 away from adhesive layer 14. The adhesive layer 14 is thereby exposed, and may be used to affix indicator 10 to food packaging or other surface. Removable release layer 12 comprises a paper, film, or foil substrate coated with a release agent. Typically, release agents are chemically based upon silicone thermosetting resins, fluorosilicone thermosetting resins, or octadecyl carbamate resins. In one embodiment, removable release layer 12 comprises silicone-treated release paper.

Adhesive layer 14 is disposed adjacent to removable layer 12 and proximate to substrate layer 16. Adhesive layer 14 preferably comprises a heat-activated, steam-activated, or pressure sensitive adhesive suitable for adhering a label to food packaging. Numerous examples of such adhesives are known in the art.

Substrate 16 is disposed proximate to adhesive layer 14 and intermediate layer 18. Intermediate layer 18 is disposed proximate to substrate layer 16 and indicator layer 20. Overlayer 22 is disposed proximate to indicator layer 20. In certain embodiments, the overlayer 22 covers and protects indicator layer 20 from abrasion and from chemical attack.

The present invention also provides a method for indicating the amount of exposure to food sterilizing radiation. The method comprises the steps of providing a multilayer radiation dosage indicator comprising (a) an indicator layer comprising an ion-sensitive ink, wherein the ink changes color upon exposure to a known amount of sterilizing radiation, (b) a label substrate, and (c) an overlayer comprising a UV absorber; and exposing the indicator to sterilizing radiation until a color change occurs. The color change may be compared to an internal or external standard to determine the amount of exposure.

In one embodiment, the food sterilization dosage indicator provides an internal standard, i.e. the indicator forms a message in words, symbol, codes, or other patterns upon exposure to sterilizing radiation. Such a message may be created by stenciling or by other methods known in the art, and is more fully described in U.S. Pat. No. 5,206,118, which is hereby incorporated by reference.

In this or other embodiments, the change exhibited by the food sterilizing dosage indicator upon exposure to sterilizing radiation may be compared to an external standard by an observer. Such external standards may include a color key that correlates colors and shades to known amounts of exposure. External shade standards include Pantone guides such as Pantone Formula Guide Solid Coated, 3^{rd} Ed. (2005-2006), available form Pantone, Inc. and hereby incorporated by reference in its entirety.

The present invention is also directed toward a method for adjusting the selectivity of the multilayer radiation dosage indicator, the method comprising the steps of (1) providing a radiation dosage indicator as described above and having an overlayer that includes a UV-absorber, and (2) selecting the amount of UV-absorber to prevent the ink from changing color upon exposure to UV radiation.

The indicator may be adapted to selectively indicate exposure to a known amount of sterilizing radiation. In one or more embodiments, the sensitivity of the indicator is determined by selecting the amount of cationic photoinitiator in the indicator layer, the type of ion-sensitive ink or cationic photoinitiator employed, the thickness of the overlayer, the type or amount of color enhancer present in the indicator layer, and the type of substrate employed. In certain embodiments, the starting and ending colors displayed by the indicator can be selecting by using certain ion-sensitive inks, or by adjusting the amount or type of color enhancer. In one embodiment, a color wheel may be employed to aid in selecting colored dyes or pigment mixtures to attain a desired color.

In one embodiment, the food sterilizing dosage indicator is adapted to indicate an exposure to about 3 kGys of sterilizing radiation. In another embodiment, the food sterilizing dosage indicator is adapted to indicate an exposure to about 5 kGys of sterilizing radiation. In yet another embodiment, the food sterilizing dosage indicator is adapted to indicate an exposure to about 9 kGys of sterilizing radiation.

In order to demonstrate the practice of the present invention, the following examples have been prepared and tested as described in the General Experimentation Section disclosed hereinbelow. The examples should not, however, be viewed as limiting the scope of the invention. The claims will serve to define the invention.

### GENERAL EXPERIMENTATION

### Example 1

An ion-sensitive ink mixture was prepared as follows. 120 parts of Polidene 33-004 was heat-treated at about 40° C. for 168 hours. 0.92 parts ethyl orange was dissolved in 4.7 parts soft water at about 49° C., then cooled to about 22° C. 1.87 parts Chivacure BF-1172 was dissolved in 4.5 parts N-methyl pyrrolidone at about 22° C. 0.026 parts FD&C Blue was dissolved in 3.474 parts water at about 22° C. The ethyl orange, Chivacure, and FD&C Blue solutions were added to the Polidene, with stirring. 2 parts Rheolate 288 was added and stirred until few or no lumps remained. The mixture was allowed to deair for about 16 hours. If any foam was observed, 2-3 drops of nonyl alcohol was added.

### Example 2

An ink mixture was prepared as for Example 1, except that the photoinitiator used in Example 2 was R-GEN 1130 instead of BF-1172. The ink mixtures of Examples 1-2 were applied to a substrate of 60 lb. Litho paper at a thickness of 1 mil, using a commercially available coating machine equipped with a wire wound bar metering system, and dried to a tack-free state to form indicator layers.

These layers were exposed to various dosages of gamma radiation, and the color change was measured by using a Pantone Book and assigned a Pantone Color Number as shown in Table 1. A Pantone Color Number of 391 corresponds to green, 198 corresponds to pink, and 201 corresponds to maroon.

TABLE 1

| Chemical | | |
|---|---|---|
| (parts by weight) | Example 1 | Example 2 |
| Polidene 33-004 | 42.0 | 42.0 |
| Water | 17.6 | 17.6 |
| Ethyl Orange | 3.53 | 3.53 |
| Rheolate 288 | 1.0 | 1.0 |
| FD&C Blue | 0.0002 | 0.0002 |
| R-GEN BF 1172 | 5.02 | — |
| R-GEN 1130 | — | 5.02 |
| Exposure dosage (kGy) | Pantone Color | Pantone Color |
| 3 | 1788 | 390 |
| 5 | 1795 | 397 |
| 9 | 1797 | 131 |

Polidene 3 3-004 is an aqueous emulsion of a vinylidene chloride copolymer, available from Scott Bader Ltd.
Rheolate 288 is polyether urea polyurethane, available from Elementis Specialties, Inc.
R-GEN BF 1172 is a substituted aryl sulfonium hexafluorophosphate salt available from Chitec Technology Co. Ltd.
R-GEN 1130 is an iodine-containing photoinitiators, available from Chitec Technology Co. Ltd.

### Examples 3-5

Example 3 was prepared as for Example 2, i.e. the substrate was 60 lb. Lithopaper. Example 4 was prepared as for Example 3, except that the substrate was 0.00035 inch aluminum foil-coated paper. Example 5 was prepared as for Example 3, except that the substrate was 0.002 inch aluminum foil-coated paper. The layers were tested and the results are shown in Table 2.

TABLE 2

| Exposure | | | | | | |
|---|---|---|---|---|---|---|
| dosage | Example 3 | Approx. | Example 4 | Approx. | Example 5 | Approx. |
| (kGy) | Pantone Color | Color | Pantone Color | Color | Pantone Color | Color |
| 1.5 | 382 | chartreuse green | 124 | almost light tan | 111 | medium olive green |
| 3 | 390 | light chartreuse | 1245 | very light olive | 118 | olive green with |
| | | | | green | | yellow |
| 5 | 397 | light chartreuse | 125 | very light olive | 131 | darker yellow tan |
| | | | | green | | |
| 9 | 131 | yellow tan | 167 | darker yellow tan | 180 | rust |
| 0 | 104 | very light olive | 3975 | darker olive green | 111 | slightly darker olive |
| | | green | | | | green |

### Examples 6-9

Examples 6-9 were prepared as for Example 1, except that the Polidene 33-004 was heat-treated at 41° C. for varying amounts of time prior to being mixed into the indicator layer mixture, as shown in Table 3. The layers were prepared and tested as for Example 1. The results are shown in Table 4.

TABLE 3

| | Example 6 | Example 7 | Example 8 | Example 9 |
|---|---|---|---|---|
| Heat | 0 | 24 | 72 | 168 |
| treatment | | | | |
| time (hours) | | | | |

TABLE 4

| | Ex 6 | | Ex 7 | | Ex 8 | | Ex 9 | |
|---|---|---|---|---|---|---|---|---|
| Exposure | Pantone | Approx. | Pantone | Approx. | Pantone | Approx. | Pantone | Approx. |
| time (sec) | No. | Color | No. | Color | No. | Color | No. | Color |
| 0 | 376 | lt. green | 376 | lt. green | 376 | lt. green | 376 | lt. green |
| 15 | 376 | lt. green | 5825 | lt. olive | 392 | darker olive | 392 | lt. olive |
| | | | | green | | green | | green |
| 30 | 384 | darker | 5825 | lt. olive | 384 | darker | 399 | darker olive |
| | | green | | green | | green | | green |
| 60 | 105 | lt. olive | 119 | olive green | 3995 | darker olive | 133 | dark green |
| | | green | | | | green | | |
| 120 | 180 | warm red | 1805 | darker | 1807 | almost | 484 | darker |
| | | | | warm red | | maroon | | maroon |
| 300 | 201 | maroon | 1815 | darker | 1955 | deeper | 202 | dark |
| | | | | maroon | | maroon | | maroon |

Thus it should be evident that the multilayer food sterilization dosage indicator of the present invention can be employed to indicate exposure to sterilizing radiation. Advantageously, the food sterilization dosage indicator can be stabilized by selection of substrate and implementation of an intermediate, inactive layer. A shade chart could be provided to indicate to the user the dosage of radiation to which the food had been exposed. The color change of the ion-sensitive ink is not reversible. Therefore, the radiation dosage indicator provides a cumulative measure of exposure to sterilizing radiation. The overlayer is resilient, and provides an improvement in abrasion resistance, water resistance, and resistance to normal exposure to sunlight or UV radiation.

While a full and complete description of the invention has been set forth in accordance with the dictates of the Patent Statutes, it should be understood that modifications can be resorted to without departing from the spirit hereof or the scope of the appended claims.

Thus, the invention is not to be unduly limited to the illustrative embodiments set forth herein.

What is claimed is:

1. A multilayer radiation dosage indicator comprising
(a) an indicator layer comprising an ion-sensitive ink, an ionic photoinitiator, and a proton source, wherein the ink undergoes a color change upon exposure to a known amount of sterilizing radiation;
(b) a substrate; and
(c) an overlayer comprising an UV-absorber.

2. The multilayer radiation dosage indicator of claim 1, wherein the substrate comprises paper, film, or foil, or combinations thereof.

3. The multilayer radiation dosage indicator of claim 1, wherein the ion-sensitive ink comprises bromochlorophenol blue sodium salt, bromocresol green ACS, bromocresol green sodium salts ACS, bromocresol purple, bromocresol purple sodium salt, bromopyrogallol red, bromothymol blue ACS, bromothymol blue sodium salt ACS, bromoxylenol blue, chlorophenol red, o-cresolphthalein complexone, o-cresolphthalein complexone disodium salt, m-cresol purple, m-cresol purple sodium salt, cresol red, cresol red sodium salt, erichrome blue black R, ethyl orange sodium salt, fast sulphon black F, litmus powder, methyl orange ACS, methyl red free acid ACS, methyl red HCl ACS, methyl red sodium salt ACS, methylthymol blue, murexide powder, nitrazine yellow, or P.A.N.

4. The multilayer radiation dosage indicator of claim 1, wherein said indicator layer further comprises a color enhancer.

5. The multilayer radiation dosage indicator of claim 1, wherein the overlayer comprises a UV-absorber selected from the group consisting of 2,2′-dihydroxy-4-methoxybenzophenone, 2[hydroxy-5-t-octylphenyl]-benzotriazole, substituted benzophenones, substituted benzotriazoles, substituted acrylonitriles, and phenol-nickel complexes.

6. The multilayer radiation dosage indicator of claim 1, wherein the ionic photoinitiator comprises an iodonium salt or a sulphonium salt.

7. The multilayer radiation dosage indicator of claim 1, wherein the proton source comprises PVDC.

8. The multilayer radiation dosage indicator of claim 7, further comprising a removable layer selected from the group consisting of silicone coated release paper, and silicone coated plastic film.

9. The multilayer radiation dosage indicator of claim 1, further comprising an intermediate layer between said substrate layer and said indicator layer.

10. The multilayer radiation dosage indicator of claim 9, wherein said intermediate layer comprises aluminum foil, polyethylene terephthalate film, aluminum metallized mylar, or coated paper, with the proviso that the paper is coated with a barrier layer that is inert to said indicator layer.

11. A method for indicating an amount of exposure to sterilizing radiation, the method comprising the step of:
providing a multilayer radiation dosage indicator comprising:
(a) an indicator layer comprising an ion-sensitive ink, an ionic photoinitiator, and a proton source, wherein the ink undergoes a color change upon exposure to a known amount of sterilizing radiation;
(b) a substrate; and
(c) an overlayer comprising a UV-absorber;
exposing said indicator to sterilizing radiation until a color change is observed.

12. The method of claim 11, wherein the indicator layer comprises a substrate comprising paper, film, or foil, and wherein the paper, film, or foil comprises a white, opaque coating.

13. The method of claim 11, wherein the ion-sensitive ink comprises bromochlorophenol blue sodium salt, bromocresol green ACS, bromocresol green sodium salts ACS, bromocresol purple, bromocresol purple sodium salt, bromopyrogallol red, bromothymol blue ACS, bromothymol blue sodium salt ACS, bromoxylenol blue, chlorophenol red, o-cresolphthalein complexone, o-cresolphthalein complexone disodium salt, m-cresol purple, m-cresol purple sodium salt, cresol red, cresol red sodium salt, erichrome blue black R, ethyl orange sodium salt, fast sulphon black F, litmus powder, methyl orange ACS, methyl red free acid ACS, methyl red HCl ACS, methyl red sodium salt ACS, methylthymol blue, murexide powder, nitrazine yellow, or P.A.N.

14. The method of claim 11, wherein the overlayer comprises a colorless lacquer mixture formed from ingredients comprising ethyl cellulose and a binder.

15. The method of claim 14, wherein the lacquer mixture further comprises a UV absorber selected from the group consisting of 2,2′-dihydroxy-4-methoxybenzophenone, 2[hydroxy-5-t-octylphenyl]-benzotriazole, substituted benzophenones, and substituted benzotriazoles.

16. The method of claim 11, wherein the photoinitiator comprises an iodonium salt or a sulphonium salt.

17. The method of claim 11, wherein the proton source comprises PVDC.

18. The method of claim 11, wherein the photoinitiator comprises bis(p-tolyl)iodonium hexafluorophosphate, or a substituted aryl sulfonium hexafluorophosphate salt.

19. The method of claim 11, further comprising an intermediate layer between said substrate layer and said indicator layer.

20. The method of claim 18, wherein said intermediate layer comprises aluminum foil, polyethylene terephthalate film, aluminum metallized mylar, or coated paper, with the proviso that the paper is coated with a barrier layer that is inert to said indicator layer.

21. A method for adjusting the selectivity of a multilayer radiation dosage indicator to sterilizing radiation, the method comprising the steps of:
providing a multilayer radiation dosage indicator comprising:
(a) an indicator layer comprising an ion-sensitive ink, an ionic photoinitiator and a proton source, wherein the link undergoes a color change upon exposure to a known amount of sterilizing radiation;
(b) a substrate; and
(c) an overlayer comprising a UV-absorber;
selecting the amount of UV-absorber in the overlayer to prevent the ink from changing color upon exposure to UV radiation.
